(19) United States
(12) Patent Application Publication
(10) Pub. No.: US 2015/0355003 A1
(43) Pub. Date: Dec. 10, 2015

(54) ACCELEROMETER-BASED SYSTEM FOR MONITORING FLOW

(71) Applicants: Bradley SAEGER, (US); William WRIGHT, (US); William DUNPHY, (US); Andrew RYDER, (US); FEEDLOGIC CORPORATION, Willmar, MN (US)

(72) Inventors: Bradley Saeger, Willmar, MN (US); William Wright, Willmar, MN (US); William Dunphy, The Villages, FL (US); Andrew Ryder, Willmar, MN (US)

(73) Assignee: Feedlogic Corporation, Wilmar, MN (US)

(21) Appl. No.: 14/760,425

(22) PCT Filed: Jan. 10, 2014
(86) PCT No.: PCT/US2014/010998

§ 371 Date: Jul. 10, 2015

Related U.S. Application Data
(60) Provisional application No. 61/751,525, filed on Jan. 11, 2013.

(51) Int. Cl. G01F 1/66

(52) U.S. Cl. CPC G01F 1/66

(57) ABSTRACT

Some system embodiments may include a flow monitor and a communication hub. The flow monitor may be configured to be mounted on a feed line. The flow monitor may include an accelerometer configured to detect vibration of the feed line. The communication hub may be configured to wirelessly communicate with the flow monitor, to receive accelerometer data from the flow monitor, and use the accelerometer data to communicate flow status information through a network to a user.

### CLAIM OF PRIORITY

This application claims the benefit of priority under 35 U.S.C. §119(e) of U.S. Provisional Patent Application Ser. No. 61/751,525, filed on Jan. 11, 2013, which is herein incorporated by reference in its entirety.

### TECHNICAL FIELD

This application relates generally to line flow systems such as feed systems, and more particularly to systems and methods for monitoring flow in lines and to related applications.

### BACKGROUND

Farms use feed lines to move feed from feed bins to livestock feeding stations. A flexible auger feed line system is a common feed line system used to feed livestock. In this system a flexible auger is operably positioned within a flexible pipe (e.g. polyvinyl chloride (PVC) pipe). A motor is connected to the flexible auger to rotate the auger and move feed through the pipe to the feed stations.

The feed flow through a flexible auger feed line system may be rated with a nominal feed flow rate. A manufacturer of the flexible auger feed line system, for example, may identify the nominal feed flow rate for when the feed line is full and the auger drive is on. However, the feed line is not always full when the auger is rotating. For example, the feed line will be empty if the feed bin, which provides the source of the feed into the feed line, is empty. Further, it is difficult to monitor the amount of feed flowing through the feed lines. For example, feed may “bridge” in the feed bin, such that the feed lines are not moving feed at full capacity.

### DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment.

Various embodiments of the present subject matter may use an accelerometer-based sensor to monitor a vibration of a line. The accelerometer-based sensor may be used to determine a line state such as “ON” or “OFF”. The accelerometer-based sensor may be used as a flow sensor, using sensed vibrations of the line to provide line flow information. Various embodiments provide a flow status signal. For example, the flow monitor may be configured to determine, based on the signal from the accelerometer, whether the line is off or on. Furthermore, the flow monitor may be configured to determine, based on the signal from the accelerometer, whether the line is “ON” and running full or “ON” and running empty. Appropriate alerts may be delivered on-site or remotely. For example, an alert may be sent if the line is OFF for too long, or if the line is ON and running full for too long, or if the line is ON and running empty for too long.

The flow monitor may be configured to provide a measure of the mass flow through the line. The measure may be based solely on the accelerometer signal, or may be based on a combination of the accelerometer signal and a load cell signal. International published patent application WO 2012027364, published Mar. 1, 2012, describes a system for metering feed in feed lines and is incorporated by reference in its entirety. For example, this published application describes system for using a load cell to meter feed, and describes embodiments of communication hubs used to provide feed flow information to user(s).

The accelerometer may be one or more single axis accelerometers or may be one or more multi-axis accelerometer. For example, various embodiments of the accelerometer-based feed monitor may use a three-axis accelerometer. The three-axis accelerometer is capable of monitoring vibration in orthogonal axes (e.g. X axis, Y axis, Z axis in a Cartesian coordinate system). The three-axis accelerometer may be mounted to a printed circuit board (PCB) inside an enclosure which is strapped to a feed line. A user interface may be used to calibrate the accelerometer. For example, a two-light system and calibration switch, similar to the load-cell based feed meter discussed in Appendix A, may be used to calibrate the device.

The system may include an analog/digital converter to convert the signals from the accelerometer to a value. The analog/digital converter may be on the PCB. Data samples are taken multiple times per second. Each sample consists of a “delta” value. This is the difference between the maximum and minimum movement on a particular axis during the sample time interval. Some three-axis accelerometer embodiments, for example, may simultaneously measure each of the three axes. In various embodiments, the sum of the totals of all three delta values are used to increase resolution and accuracy. Detecting movement side to side and forward and backward provides added clues as to the changing volume of feed in the line.

Patterns created by the changing state of a feed line are easily detectable. When the feed line is idle, the delta values measured by the accelerometer are very low. When the feed line is running in an empty state, the vibration and movement delta values are at a maximum. When the feed line is running and contains feed, the vibrations are dampened. The volume of feed (mass flow) in the line can be deduced by monitoring the difference in delta values between the Empty and Full states. Various signal processing techniques may be implemented to evaluate the accelerometer signals. For example, an embodiment uses a range of delta values (“delta value bands”). One delta value band may indicate that the line is OFF. Another delta value band may indicate that the line is ON and empty. Another delta value band may indicate that the line is ON and full. Additional bands may be used (e.g. ON 50% full, etc.). Furthermore, some embodiments provide a measure or estimate of the mass flow through the line where the mass of feed can be deduced by measuring the base frequency of the line vibrations.

By way of example, the system may be calibrated using a user interface. The user interface may be designed to provide a simple and rugged output such as lights and a simple and rugged input such as a calibration switch. The system may be calibrated by toggling the calibration switch with the line running empty and then with the line running full. The system samples accelerometer values for a period of time and may use lighting patterns to provide indications of calibration status to the user. The lights may also provide feedback to the user of calibration errors. The user may input the feed line's flow rate, typically determined by running feed from a fully flowing line into a pail and weighing the feed back on a static scale to determine a mass/minute value (lbs or kgs/min). This flow rate value may be entered into a user interface for the system and used to calculate the mass flow of feed. Partial flow rates may be calculated as a percentage of full value. A linear function between the empty line data and full line data may be assumed for various applications as the linear function has been shown to provide good estimations of mass flow data. Non-linear functions may also be implemented. The non-linear algorithms may be derived by running partial flow rate tests at different percentages of the full value.

The capture and reporting of feed event data may occur similar to that as discussed in International published patent application WO 201202736, which was previously incorporated by reference in its entirety. 14. In some embodiments, the system may be configured to detect that the line has started when the accelerometer detects movement which is a specific percentage higher than the IDLE state for a specified period of time (to eliminate any temporary jolts to the line by extraneous sources). This Start event may be time stamped and the system begins sampling accelerometer data and translating it into mass flow. As soon as the accelerometer detects movement in the IDLE state band, it may record a Stop event and sums the total mass of feed that passed through during that event.

Some embodiments may monitor the start and stop times. Some embodiments may monitor the duration of the ON time between the start time and stop time.

Benefits of the accelerometer-based flow monitor may include the ability of the flow monitor to be mounted on a line in any orientation—top, bottom, or side. The orientation does not affect its ability to detect movement and mass flow. As such, the monitor provides flexibility in mounting, providing the capability of being mounted in some tight spaces. Further, the flow monitor need not be attached to a building structure (e.g. truss). Thus, the flow monitor naturally has some isolation from building vibration that may be caused by wind or other machinery.

Benefits of the accelerometer-based flow monitor may include the data processing and interpretation performed by software in the hub. Raw accelerometer data may be sent from the flow monitor to the hub, making it easier and less expensive to change or update algorithms on field installed equipment and reducing PCB processor costs.

Some embodiments maybe configured with an “auto calibration” capability. The flow meter may be configured automatically “finds” the IDLE, FULL, and EMPTY values after the user straps it to a line and runs the line for a specific period of time in each state.

Software in the hub may allow the detection of out-of-normal states with feed flow (excessive flow, no flow, restricted flow) while the feed line is running and report that through a telemetry solution to the user via email or SMS. Thus, an active alert may be delivered without the need to wait until the end of a run event to send out an alert.

Other models, sampling rates, and calibration procedures may be used to provide more accurate measures of mass flow. Furthermore, changes may be made to provide less accurate measures of mass flow if the less accurate measures of mass flow are sufficient for the user, and the additional accuracy does not warrant the additional time or expense to obtain more accurate measures.

Provided below are examples of using the flow monitor for livestock feed systems. However, the flow monitor may be used to monitor other flow of material. The monitored material flow may be liquid or non-liquid material.

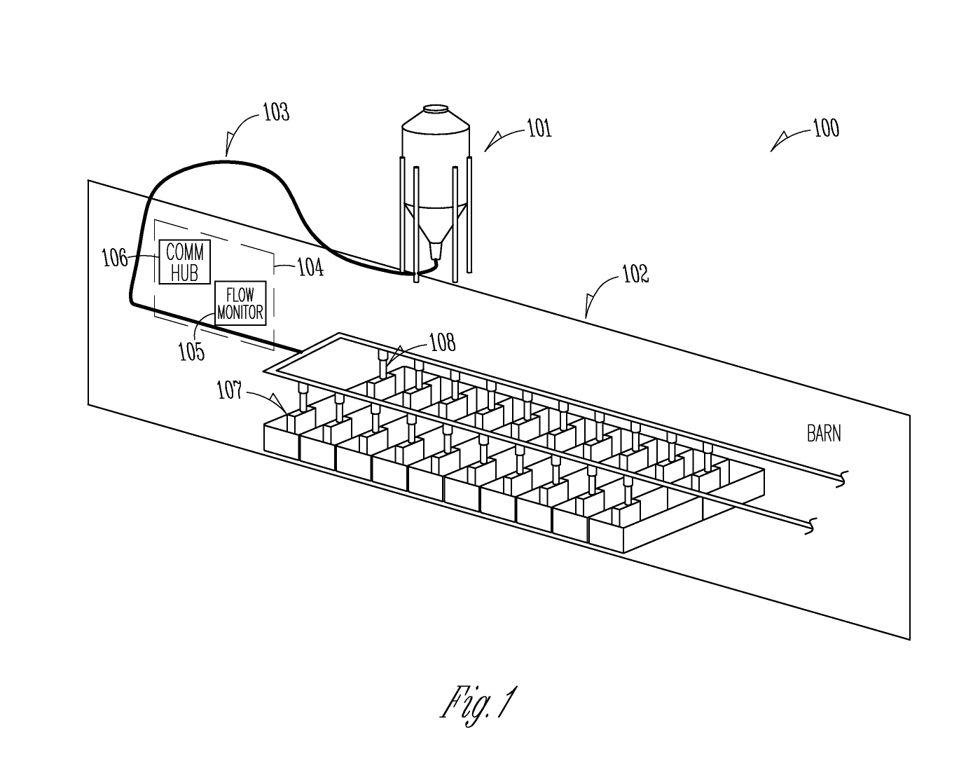

FIG. 1 illustrates an embodiment of a feed line system with a flow monitor. In some embodiments, a flow monitor may be used to provide a measure of mass flow and functions as a feed meter. The illustrated system 100 may include a feed bin 101 next to a livestock barn 102. A feed transport system 103, such as a flexible auger system for example, draws feed from the feed bin 101 and delivers the feed into the barn 102. The feed system 100 may include a flow monitor system 104, which includes a flow monitor 105 operationally attached to the feed line to monitor flow and in some embodiments determine a mass flow rate. The system may also include a communication hub 106 configured to communicate with the flow monitor 105 and communicate with work station(s) or other device(s) to communicate information pertaining to the flow of the feed and to communicate other information. The work station(s) or other device(s) may be local or remote. The information may be raw accelerometer data, operation timing such as start, stop and/or duration, processed data to provide a mass value, processed data to provide a mass flow value, or various notices (e.g. messages, alarms, alerts) concerning the mass flow of feed. The communication may be used to enable the presentation and/or processing of the feed meter data. The flow monitor can be used to measure mass flowing in the flexible auger and provide a mass/time calculation (e.g. pounds or kilograms per minute or pounds or kilograms per second). The flow monitor may store the mass flow rate data locally, or store the mass flow rate data in the communication hub or in other devices that communicate directly or indirectly with the communication hub.

The communication hub 106 may send data, over wired and/or wireless connections, to other devices. For example, the communication hub may be wirelessly 106 networked to one or more flow monitors 105. The feed is delivered past the feed meter through the flexible auger system to drop tubes used to deliver the feed down to the feeders. An auger motor operates intermittently to deliver the feed from the feed bin to the drop tubes 107 and into the feeders 108.

In operation, feed is moved through a flexible pipe using a flexible auger operably positioned within the pipe. Feed flow is monitored using an accelerometer-based flow monitor attached to the flexible pipe.

The flow monitor may be positioned at a variety of positions along the feed transport system. For example, a flow monitor 105 may be positioned between the point where feed enters the building and a first drop tube to a feeder. A flow monitor may be positioned at a drop tube to monitor timing (e.g. ON, OFF or duration) or flow.

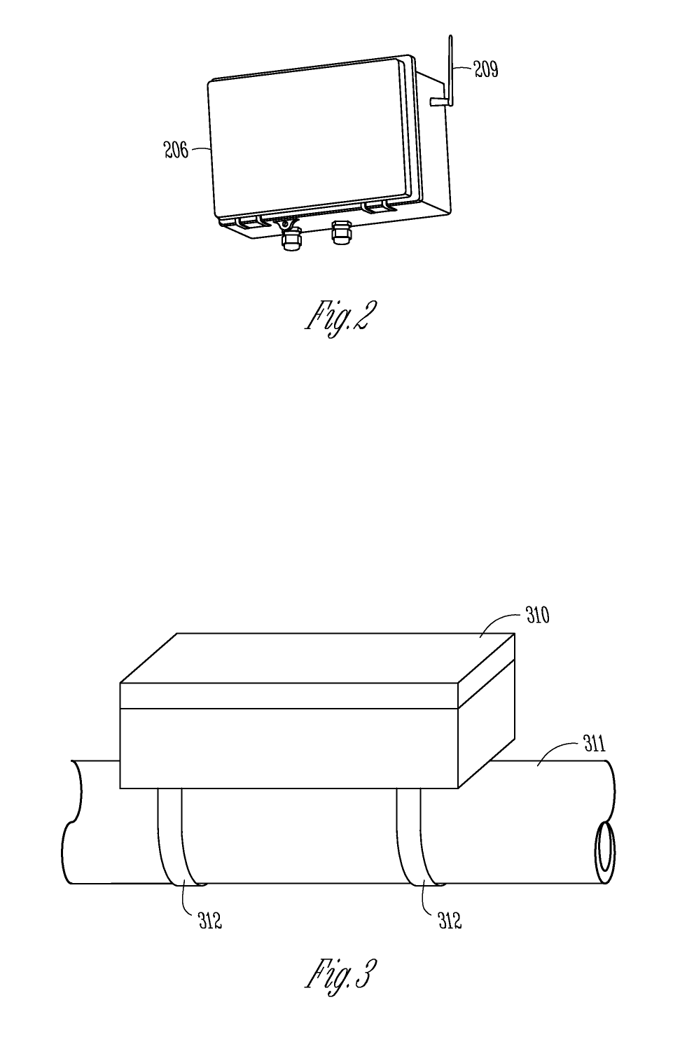

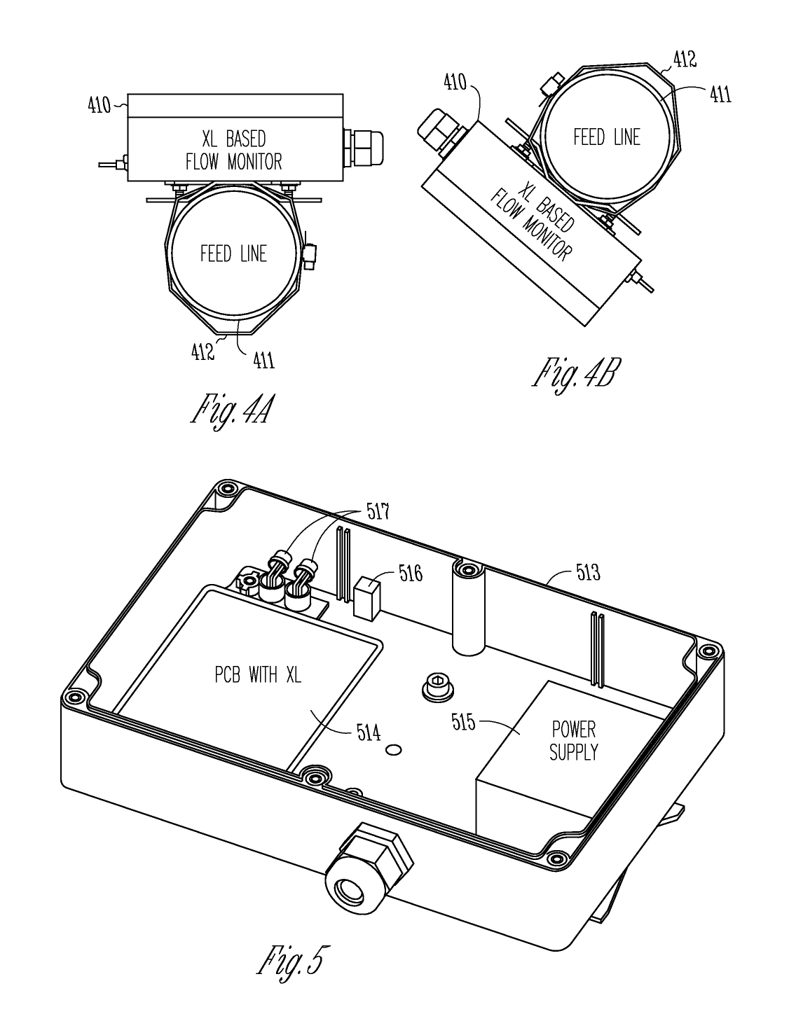

FIG. 2 illustrates an example of a wireless version of communication hub, and FIG. 3 illustrates an embodiment of an accelerometer-based flow monitor. The communication hub 206 includes an antenna 209, and the flow monitor 310 may include an antenna (not shown). The flow monitor 310 may be attached to a feed line 311 using clamps 312. The flow monitor 310 and communication hub 206 include circuitry configured to provide wireless communication using the antennas. Some embodiments use a wired connection between the flow monitor 310 and the communications hub 206 instead of a wireless communication connection. The communication hub 206 includes appropriate circuitry configured to communicate with other device(s) and send the feed meter data out to these other device(s). In some embodiments, the communication hub 405 communicates alarms or alerts local with respect to the communication hub, or at local work station(s) in the barn or on the farm where the feed meter is located, or at remote work station(s) off the farm where the feed meter is located. The communications hub may communicate over a local area network or a wide area network to provide information to a user. This information may include information pertaining to the measure of the mass flow of the feed. For example, a user may log into a website to monitor the feed usage and feed inventory for a feed line in a barn

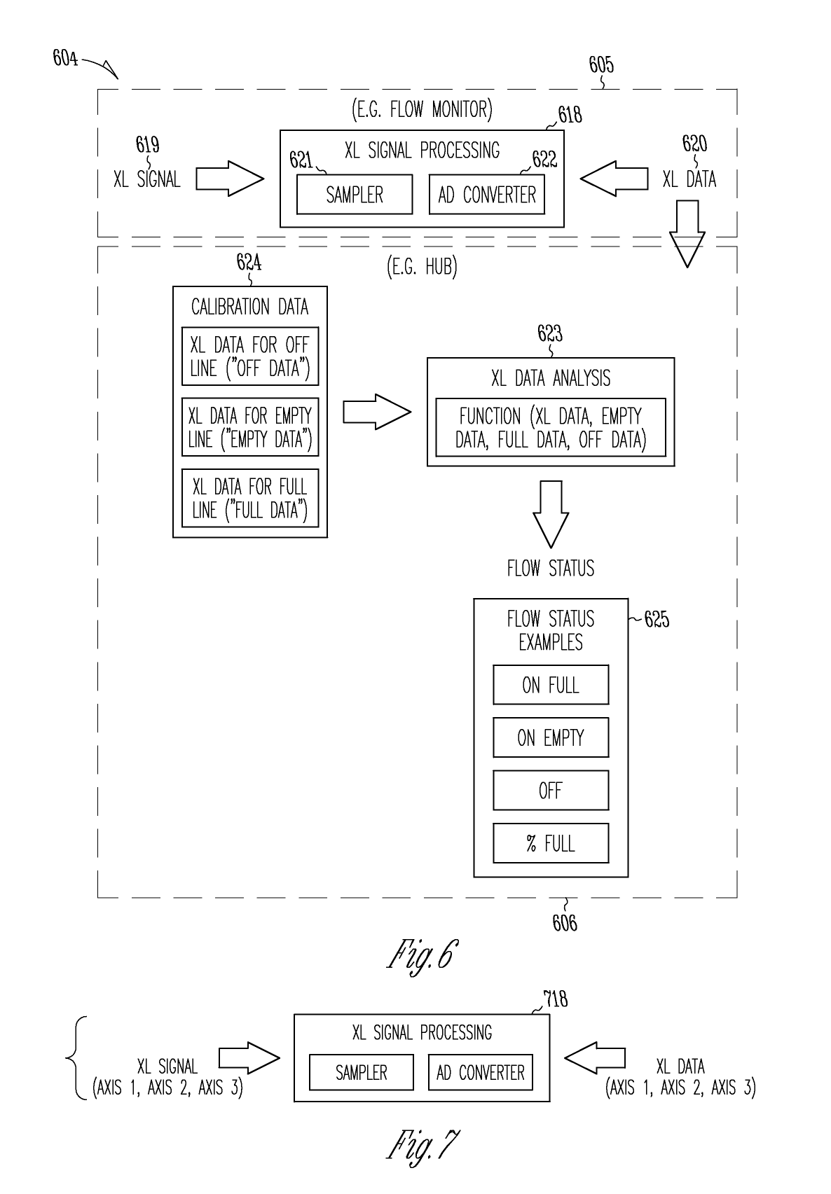

FIGS. 4A and 4B provide a cross-sectional view through a feed line to illustrate, by way of example, different positions and orientations (e.g. top, side, bottom, etc.) for attaching a flow monitor may 410 to a feed line 411. The clamp 412 is capable of securely attaching the flow monitor 410 to the feed line at different angles, such that the monitor may be attached to feed lines near a roof line/wall of a building, for example.

FIG. 5 illustrates an interior of an example of the flow monitor 510. For example the flow monitor 510 may include a housing 513. The housing 513 may include that include a printed circuit board (PCB) 514 with an accelerometer and a power supply 515. The flow monitor may include a calibration switch 516 and LED calibration/status lights 517 to provide a user interface outside of the housing. The switch and lights are connected to the PCB within the housing.

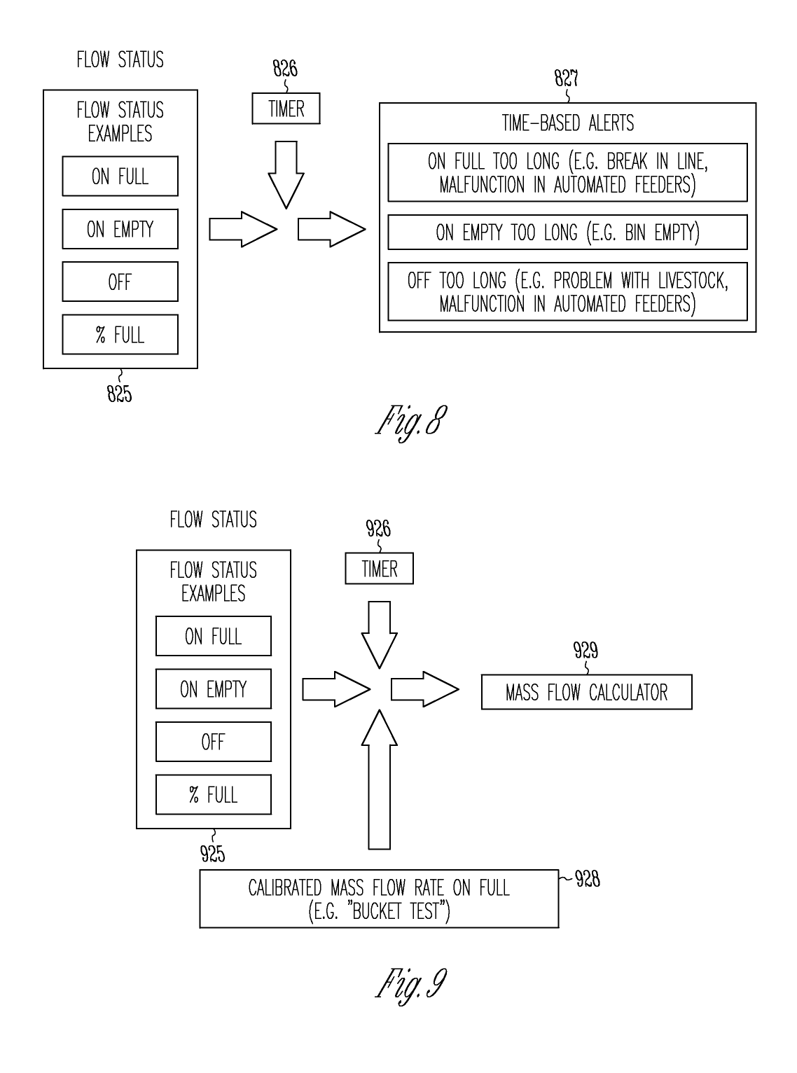

FIG. 6 illustrates, by way of example, an embodiment of a flow monitor system 604. The system 604 includes components that may, but are not necessarily, separated into separate devices such as a flow monitor 605 and a hub 606. The system 604 includes an accelerometer signal processing module 618 configured to receive and convert a raw accelerometer signal 619 into accelerometer data 620. The accelerometer signal processing module 618 may include a sampler 621 configured to sample the analog accelerometer signal 619 and an analog-to-digital (AD) converter 622 configured to convert the sampled signal into a digital signal 620. The system 604 may include an accelerometer data analysis module 623 to receive the digitized accelerometer data 620. The accelerometer data analysis module 623 may be configured to perform a function to analyze the data 620 to determine a state of the system. Calibration data 624 may be determined from calibration routines. This calibration may be used for specific line to detect the values associated with the accelerometer signal for a specific line to determine the OFF data when the line is off, the EMPTY data when the line is running and empty, and FULL data when the line is running and full. Inputs to the accelerometer data analysis module 623 may include the accelerometer data 620 and the calibration data 624 such as empty data representing the accelerometer data when the line is empty, full data representing the accelerometer data when the line is full, and/or off data representing accelerometer data when the line is not operating. The accelerometer data analysis module 623 may output a status of the line. For example, the line status may be an ON or OFF status. The line status may be a flow status 625 such as an ON FULL flow status, or an ON EMPTY flow status, or an OFF status, or a % FULL flow status.

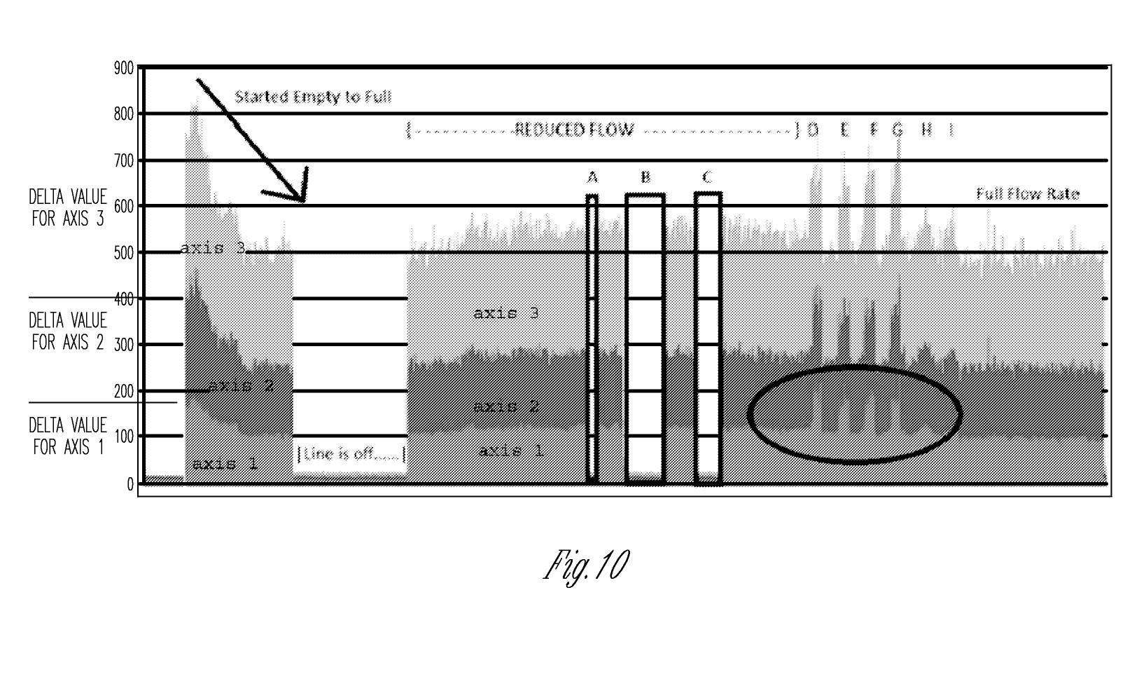

FIG. 7 illustrates an example of an embodiment of an accelerometer signal processing module 718, similar to that illustrated at 618 in FIG. 6. The accelerometer signal module 718 may receive and convert multi-axis accelerometer signals into multi-axis digital signals. For example the accelerometer signal module 718 may be configured to convert the axis 1 signal, the axis 2 signal and the axis 3 signal into an axis 1 digital signal, an axis 2 digital signal, and an axis 3 digital signal.

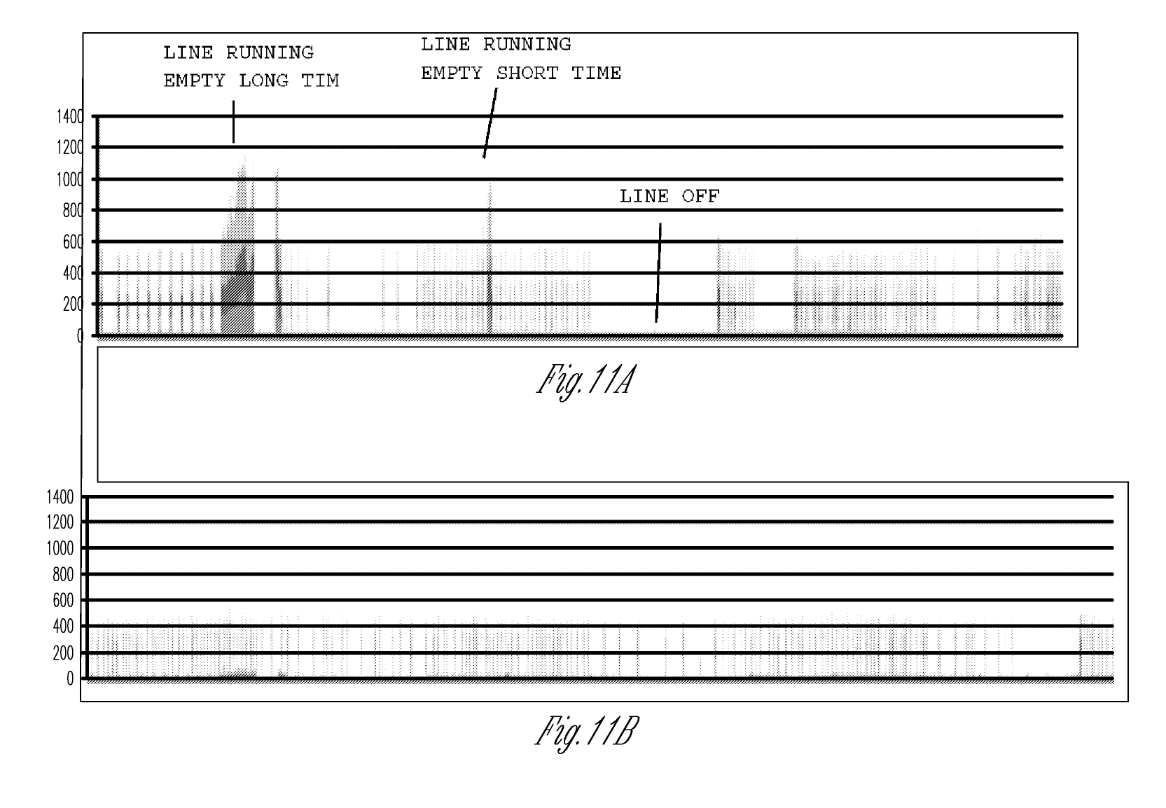

In some embodiments, the flow monitor system may be configured to use the flow status, such as generated in FIG. 6, to provide time based alerts. FIG. 8 illustrates an example of a system configured to provide time-based alerts from flow status 825 which is derived from the accelerometer signals. The system may include a timer 826. The timer 826 and flow status 825 may be used to generate time-based alerts 827 for the flow status. Examples of such alerts may include ON FULL TOO LONG which may indicate a break in the line or a malfunction in automated feeders, ON EMPTY TOO LONG which may indicate that the bin is empty, and OFF TOO LONG which may indicate a problem with the livestock or a malfunction in an automated system.

In some embodiments, the flow monitor system may be configured to use the flow status, such as generated in FIG. 6, to calculate mass flow. FIG. 9 illustrates an example of a system configured to provide mass flow calculations flow status 925 which is derived from the accelerometer signals. The system may include a timer 926. The system may also have calibration data for a mass flow rate when the line is ON and is FULL 928. For example the line may be turned on and the feed may be collected in bucket. A mass flow value may be calculated from the mass of the feed in the bucket and the duration of time that the line was turned ON. A mass flow calculator 929 may be used to provide a mass flow value based on a flow status 925.

The accelerometer system may be used to determine the actual flow rate over time. A flow rate value from the static weighing at calibration may be used to calculate the flow rate in real time as the feed line is running. Frequencies from the accelerometer may be sampled multiple times a second. The flow rate may be calculated at a percentage of the calibrated flow rate. So for example if the line had been calibrated FULL at 30 lbs/min flow rate with an accelerometer frequency value of 400 and EMPTY at a frequency of 1000, the difference between full and empty is a span of 600. Thus, when a line is running at a detected frequency value of 700 (halfway between 400 and 1000), the flow rate may be determined to be 50% of the flow rate (15 lbs/minute). The frequency samples may be averaged over time to eliminate any outliers and provide a more accurate flow rate value. Thus, as the system self-calibrates to a data set, the system becomes more accurate with time because it has a larger data set.

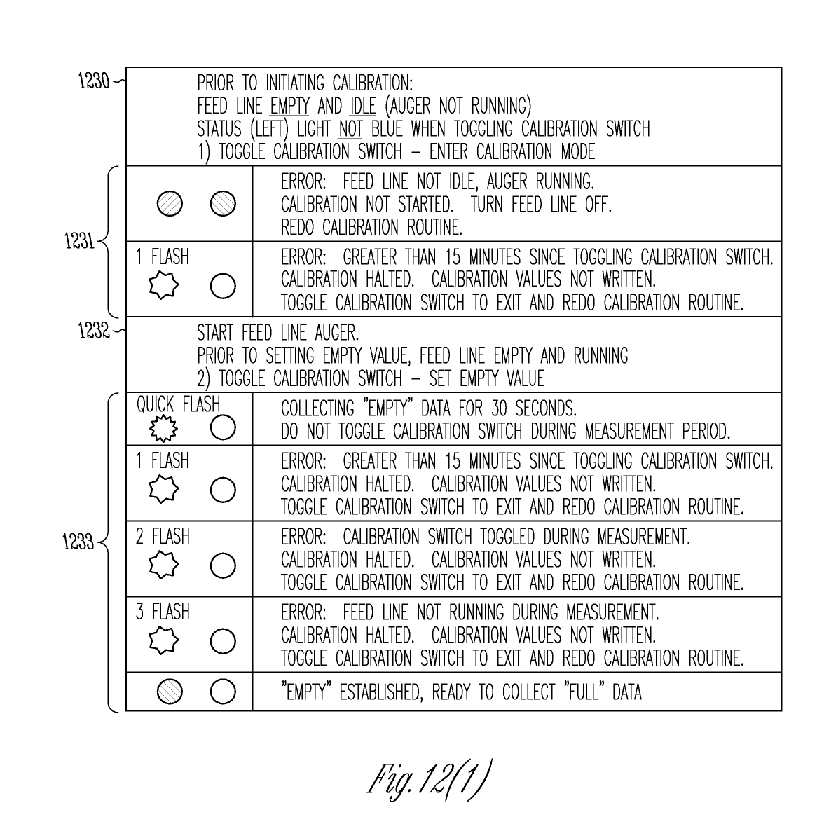

FIG. 10 illustrates the summed delta values for each axis of the three axis accelerometer. It illustrates that the sum for an empty line (start) is consistently high, and a full line is consistently lower, and an OFF line is negligible. Further, it illustrates that the raw accelerometer date provides a good representation of reduced flow. A, B, C are instances when the line was turned off. D, E, F, G are instances where the gate was closed or greatly reduced to reduce the mass flow through the line. All three axes provide consistent data.

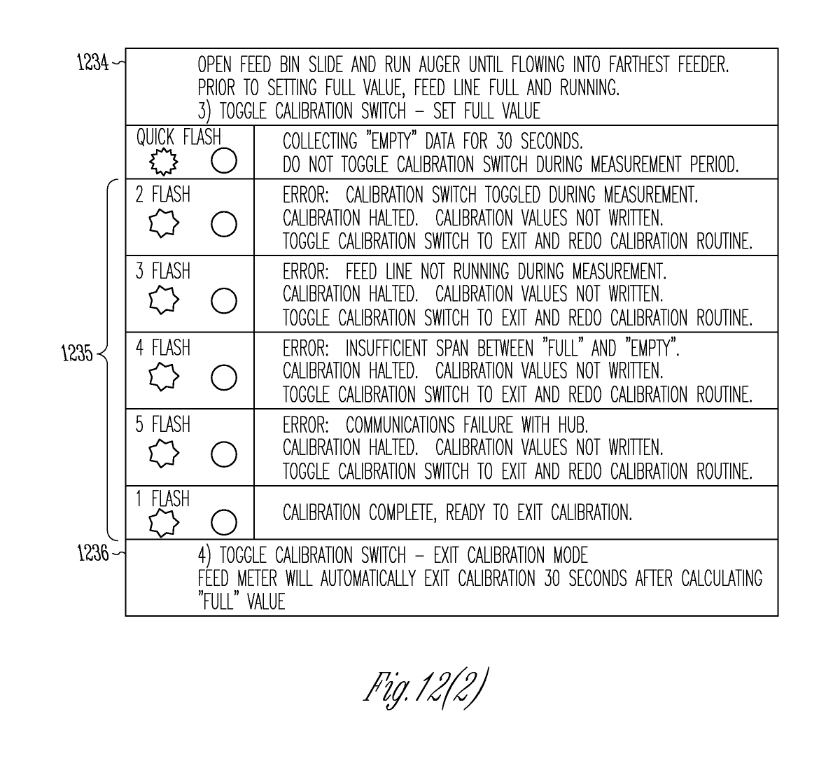

FIGS. 11A and 11B illustrate that the raw data itself provides a good visual of the operation of the line. For example, FIG. 11A illustrates times where the line operated empty including longer time where the line ran empty, and further indicates long times where the line did not turn on. In contrast, FIG. 11B illustrates that the line is operating normally and as expected as the line is intermittently ON and full.

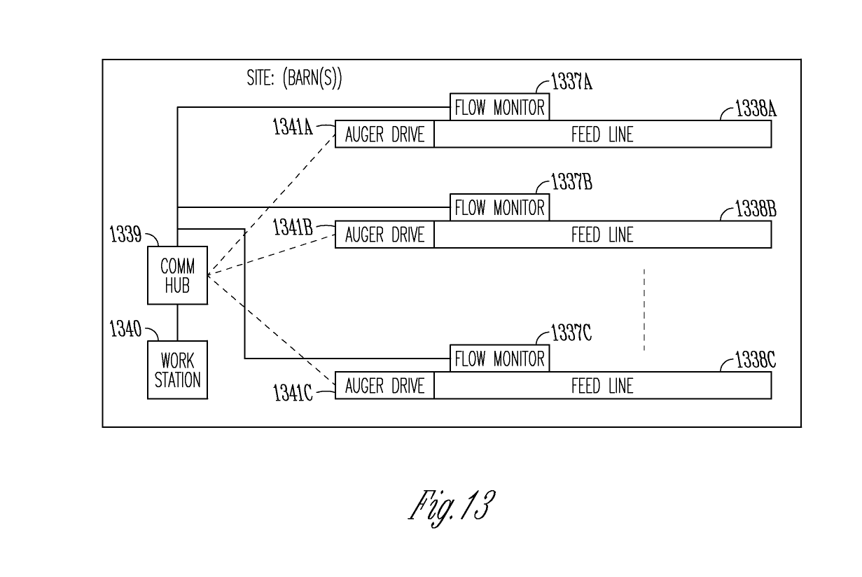

FIG. 12 illustrates a calibration routine. Calibrating the feed flow monitor to create calibration data may include running the flexible auger when the flexible pipe is empty and set an ON EMPTY value to indicate an accelerometer reading when the flexible auger is running and the flexible pipe is empty, and running the flexible pipe when the flexible pipe is full with feed and set a ON FULL value to indicate an accelerometer reading when the flexible auger is running and the flexible pipe is full.

For example, when the line is empty and idle, the calibration mode may be entered by toggling the calibration switch 1230. The lights may be used to identify errors in the calibration routine as illustrated at 1231. The feed line is started so that the feed line is empty and running. The calibration switch may be toggled to set an empty value 1232. The lights may be used to identify the status (e.g. collecting data or empty established) or errors for calibrating the empty on value 1233. The feed bin slide may be opened and the feed line may be turned on to transport feed to the farthest feeder so that the feed line is full and running, and the switch may be toggled to set a full value 1234. The lights may be used to identify the status (e.g. collecting data or calibration complete) or errors for calibrating the full on value 1235. The toggle switch may be used to exit the calibration mode, or the system may automatically exit the calibration mode after a programmed time period after calculating the full value 1236.

FIG. 13 illustrates an example of a system embodiment with multiple flow monitors (or accelerometer-based feed meters) connected to a communication hub. The system may include multiple flow monitors 1337A-C. The feed meter system may be on a single farm site that may include one or more barns. The feed meter system may include feed lines 1338A-C. The system may include a communication hub 1339 configured to communicate with each of the flow monitors 1337A-C. The communication from the communication hub may be a wired connection, or may be a wireless connection. The communication hub is also connected to a work station 1340 on-site, which can be used to monitor the feed flow through the feed lines. A personal computer may be programmed to function as the work station, for example. The work station may be in the barn, or in one of the barns, or in another building on the farm site. The communication between the communication hub and the work station may be wired or wireless connection. In some embodiments, a user communicates to the communication hub, or to the feed meter through the communication hub, using a web browser. This web browser may be on the local work station, and may communicate with the communication hub through an Ethernet cable or other wired connection. In some embodiments, the communication hub 1339 further includes a communication connection to the auger drives 1341A-C. The auger drives are motors that turn the augers within the flexible auger feed lines. The communication connection to the auger drives allow the communication hub to detect whether the auger drives are operating, and in some embodiments control the on/off control of the auger drives. For example, some embodiments of the communication hub provide notice(s) or alert(s) such as identified in FIG. 8, and also send commands to control the auger drive. In another example, some embodiments of the communication hub provide notice or alert(s) if the detected mass flow of the feed is out of the range of normal values, and can control the auger drive to only allow the auger drive to run for a set period of time. The system may be configured to initiate the control of the auger drives at the communication hub or at the work station.

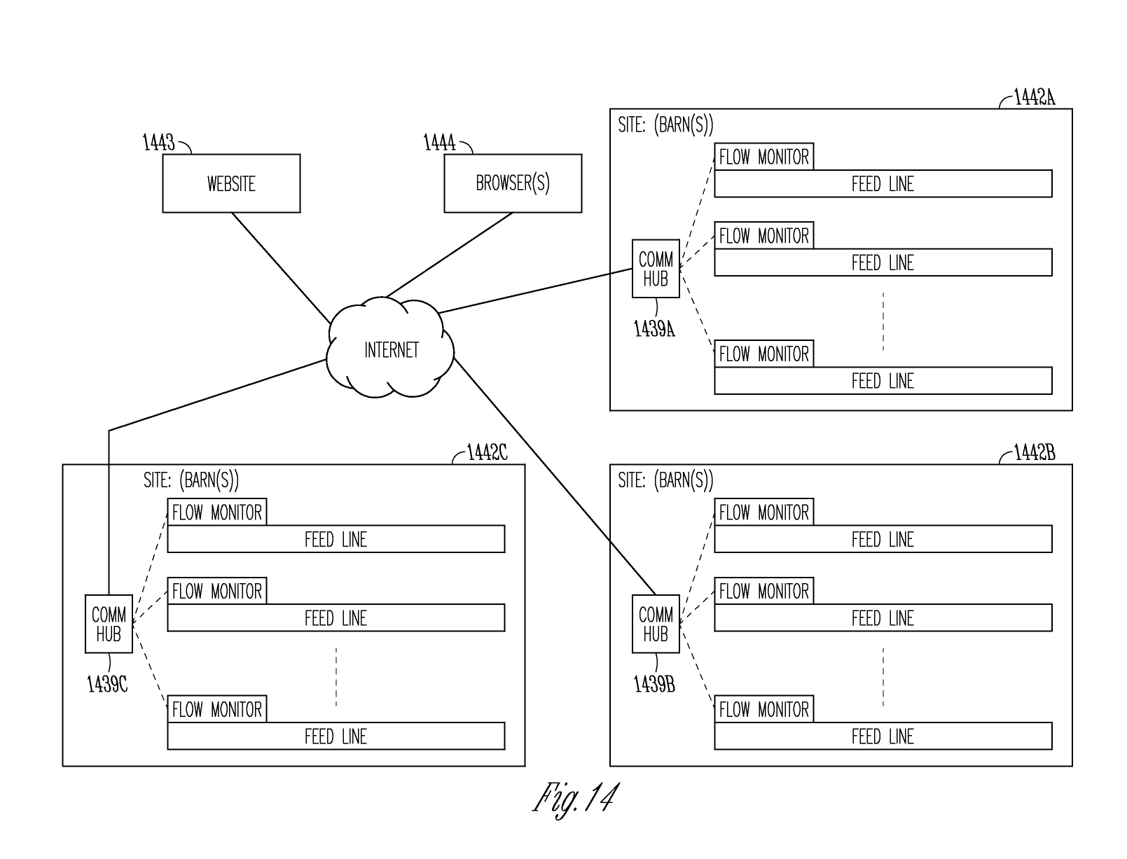

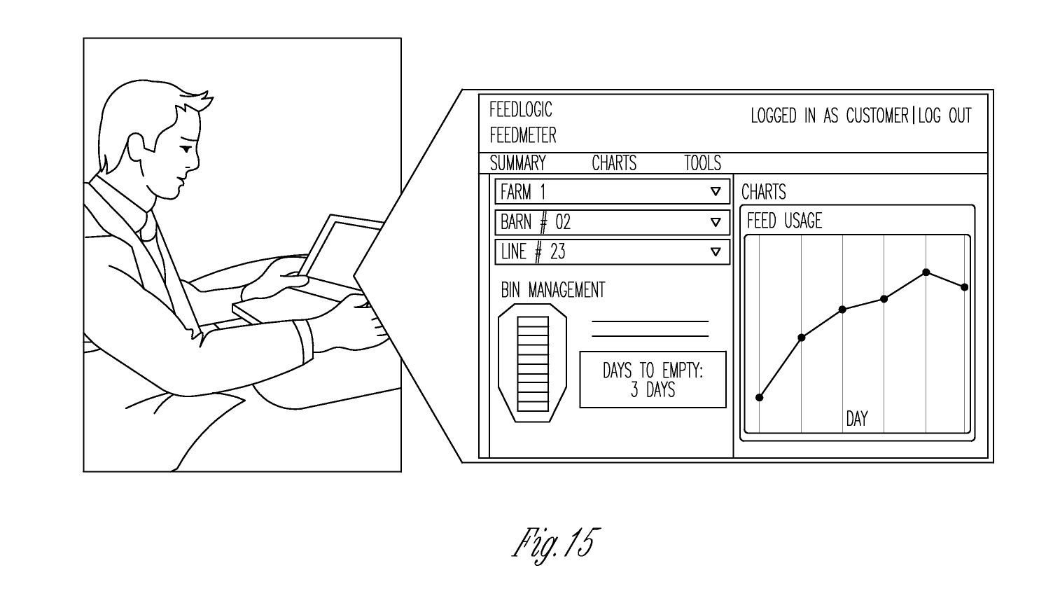

FIG. 14 illustrates a system similar to FIG. 13, where multiple communication hubs at different site(s) provide data to a remote user. The illustrated system includes three separate sites 1442A-C, where each site includes a communication hub 1439A-C to communicate with the feed meters at the site. The communication hubs may also be configured to control auger drives, such as is illustrated with respect to FIG. 13. The communication hubs are configured to connect, using wired and/or wireless connections, to a website 1443 through an Internet connection to push the feed meter data to the website. The website is accessible through browser(s) 1444 operating on desktop computer(s) or operating on portable device(s) that are capable of accessing web pages through the Internet connection such as notebook or laptop computer(s), smart phone(s), and tablet(s). FIG. 15 illustrates an example of a user interface providing a remote user with flow information or alerts. The information or alerts may be pushed onto mobile devices, such as smart phones or tablets. The user is monitoring feed usage for feed line 23 in barn 2 at farm 1. The website communicates through the browser the estimated days to an empty bin is three days. In some embodiments, the system is configured to allow a remote browser to access and program user-settable features within the communication hub, or access and program user-settable features within the feed meter through the communication hub.

Some embodiments use a visual alarm such as a flashing red light on the communication hub, by way of example and not limitation, to indicate a fault condition or to alert the user of a condition of the feed system (e.g. an empty or near empty feed bin or an empty or near-empty micro-ingredient container or detected bridging of feed within the feed bin). Some embodiments send email, text message, and/or place a telephone call upon an alarm condition using a wireless or Ethernet connection from the device to an outside communications service. Some embodiments implement a number of optional and user-settable fail-safe conditions, such as stopping the lines if one of the lines is empty or malfunctioning.

The programming monitors input channels to determine the line status such as a flow status. An input channel is monitored to detect that the auger motor is operating. Some system embodiments control the auger motor [on/off] through the use of an output channel. When the software detects that the auger is operating, the system may continuously monitor the flow of feed. Some system embodiments maintain an internal database recording events and durations. Device activities/events are recorded and time stamped.

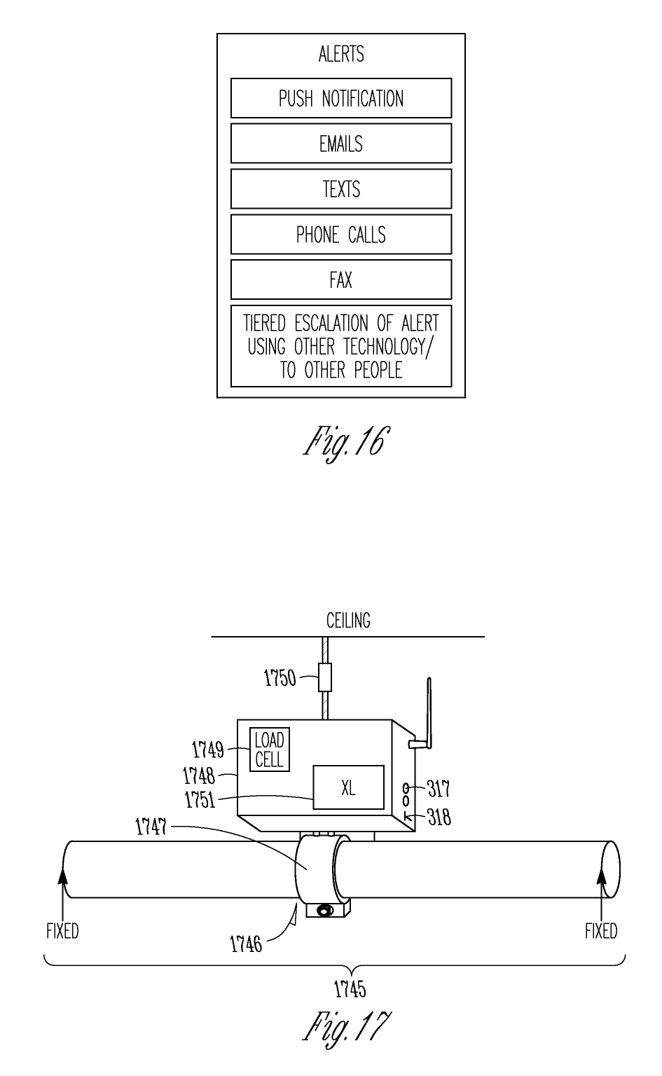

FIG. 16 illustrates various alert mechanisms. Different line statuses may use different alert mechanism. For example alert(s) may be delivered using push notification to mobile devices (e.g. mobile phones/tablets), using emails, using text messages, using phone calls, using faxes, etc. Some embodiments may implement a tiered escalation of alerts using other technology and/or sent to other people. By way of example and not limitation, a first tier of alerts may be an email to an operator. If the condition does not get fixed or if the email does not get acknowledged, then a second tier may send a push notification, text or phone call to the operator. If the condition still does not get fixed or the alert(s) are not acknowledged the alert may be broadcasted to multiple people.

FIG. 17 illustrates a feed meter with both an accelerometer and a load cell. The use of the accelerometer and the load cell provide additional information that can improve the accuracy of the system. The feed meter may be attached to a section 1745 of a flexible auger pipe. The section 1745 of pipe does not need a special connection to the flexible auger system. Rather, the section 1745 of pipe may form an integral part of a longer pipe. The length of the section 1745 between the fixed ends may be about eight feet, for example. Each end of the section is fixed. For example, each end of the section may be fixed to a structure within a barn, such as a truss, rafter or joist of the barn to greatly reduce movement of each end of the section. The center portion 1746 of this section of the flexible auger pipe, positioned between the fixed ends, is free to flex under the weight of the feed flowing through this section. The feed meter is attached to the center portion of this section and to the structure such as to the roof of the barn, and is configured to provide a measure of the feed mass in the section of the flexible auger pipe. The illustrated feed meter may be configured to be attached to a structure, such as a building structure like a ceiling of the barn, and includes a clamp 1747 configured to clamp around the center portion of the section of the flexible auger pipe. The clamp can be designed to accommodate different standard and non-standard pipe sizes. When feed is in the section 1745 of pipe, the center portion 1746 flexes down away from the ceiling. The feed meter 1748 includes a load cell 1749 configured to provide a measure of the strain induced by feed moving in this section 1745 of the flexible auger pipe. The illustrated feed meter also includes a tension adjustment 1750, illustrated as a turn buckle, which is used to adjust the tension between the building structure and the pipe. This can be used to set the range of tension applied to the load cell in an operable range for the load cell. The feed meter 1748 may also include an accelerometer 1751 to sense vibrations in the flexible auger pipe. The flexible auger pipe includes a flexible auger within the flexible pipe. Some embodiments of the feed meter include an inductive sensor configured to sense when the flexible auger is close to the inductive sensor. Some embodiments use the inductive sensor to determine if the flexible auger and the auger drive is on or if the flexible auger is not moving and the auger drive is off. Instead of using an inductive sensor, some embodiments of the feed meter use the load cell to detection vibration in the pipe that indicates a rotating flexible auger. The above detailed description is intended to be illustrative, and not restrictive. The scope of the invention should, therefore, be determined with reference to the appended claims, along with the full scope of equivalents to which such claims are legally entitled.

What is claimed is:

1. A system, comprising:
a flow monitor configured to be mounted on a feed line, the flow monitor including an accelerometer configured to detect vibration of the feed line; and
a communication hub configured to wirelessly communicate with the flow monitor, to receive accelerometer data from the flow monitor, and use the accelerometer data to communicate flow status information through a network to a user.

2. The system of claim 1, wherein the system includes an accelerometer data analysis module configured to provide a flow status based on the detected vibration of the feed line.

3. The system of claim 2, wherein the system includes an accelerometer signal processing module configured to convert an analog accelerometer signal into a digital accelerometer signal, the accelerometer data analysis module configured to analyze the digital accelerometer signal.

4. The system of claim 2, wherein the system includes calibration data, including accelerometer data for the feed line when off, accelerometer data for the feed line when full and empty, and accelerometer data for the feed line when full and on.

5. The system of claim 4, wherein the accelerometer signal processing module is configured to use the calibration data to provide a flow status based on the detected vibration of the feed line.

6. The system of claim 5, wherein the flow status includes ON and OFF.

7. The system of claim 5, wherein the flow status includes ON EMPTY and ON FULL.

8. The system of claim 7, wherein the flow status includes % FULL.

9. The system of claim 4, wherein the system is configured to provide a time-based alert based on a value of the flow status and a duration that the flow status is at the value.

10. The system of claim 9, wherein the time-based alert includes an ON FULL too long alert.

11. The system of claim 9, wherein the time-based alert includes an ON EMPTY too long alert.

12. The system of claim 9, wherein the time-based alert includes an OFF too long alert.

13. The system of claim 1, wherein the accelerometer includes a multi-axis accelerometer.

14. The system of claim 13, wherein the multi-axis accelerometer includes a three-axis accelerometer.

15. The system of claim 1, wherein the flow monitor includes a housing and a clamp, wherein the clamp is configured to be positioned around the feed line and clamp the housing to the feed line.

16. The system of claim 1, wherein the communication hub is configured to provide a measure of mass flow over time based on the accelerometer data and a calibrated flow rate.

17. A method, comprising:
moving feed through a flexible pipe using a flexible auger operably positioned within the pipe; and
monitoring feed flow through the flexible pipe using a flow monitor attached to the flexible pipe, wherein the flow monitor includes an accelerometer configured to detect vibration of the flexible pipe.

18. The method of claim 17, further comprising calibrating the feed flow monitor to create calibration data, including:
running the flexible auger when the flexible pipe is empty and set an ON EMPTY value to indicate an accelerometer reading when the flexible auger is running and the flexible pipe is empty; and
running the flexible pipe when the flexible pipe is full with feed and set a ON FULL value to indicate an accelerometer reading when the flexible auger is running and the flexible pipe is full.

19. The method of claim 18, further comprising providing a flow rate over time based on the calibration data and the detected vibration of the flexible pipe.

20. The method of claim 19, further comprising providing one or more time-based alerts using the flow status and a timer, wherein the time-based alerts include at least one alert selected from the group of alerts consisting of:
an ON FULL too long alert;
an ON EMPTY too long alert; and
an OFF too long alert.

21. The method of claim 19, further comprising providing a mass flow calculation based on flow status, a calibrated mass flow rate, and a timer.

22. The method of claim 17, further comprising sending an alert regarding the monitored feed flow, wherein sending the alert includes:
providing a push notification;
sending a text message;
sending an email;
sending a fax; or
placing a phone call.
